(19) United States
(12) Patent Application Publication
(10) Pub. No.: US 2009/0158323 A1
(43) Pub. Date: Jun. 18, 2009

(54) Method and apparatus for video navigation

(76) Inventors: Miroslaw Bober, Guildford (GB); Stavros Paschalakis, Surrey (GB)

Correspondence Address: BIRCH STEWART KOLASCH & BIRCH, PO BOX 747, FALLS CHURCH, VA, 22040-0747, US

(21) Appl. No.: 11/991,092

(22) PCT Filed: Sep. 7, 2006
(86) PCT No.: PCT/GB2006/003304

§ 371 Date: Jul. 30, 2008

(30) Foreign Application Priority Data
Sep. 9, 2005 (GB) 0518438.7

(51) Int. Cl. H04N 5/445

(52) U.S. Cl. 725/37

(57) ABSTRACT

A method of deriving a representation of a video sequence comprises deriving metadata expressing at least one temporal characteristic of a frame or group of frames, and one or both of metadata expressing at least one content-based characteristic of a frame or group of frames and relational metadata expressing relationships between at least one content-based characteristic of a frame or group of frames and at least one other frame or group of frames, and associating said metadata and/or relational metadata with the respective frame or group of frames.

The invention relates to a method and apparatus for navigating and accessing video content.

WO 2004/059972 A1 relates to a video reproduction apparatus and skip method. Video shots are grouped into shot groups based on shot duration, i.e. consecutive shots with a duration less than a threshold are grouped together into a single group, while each shot with a duration more that the threshold forms its own group. Based on this, the user may, during playback, skip to the next/previous shot group, which may result in a simple skip to the next/previous group, or skip to the next/previous long-shot-group depending on the type of the current group and so on.

One drawback of the method is the segment creation mechanism, i.e. the way in which shots are grouped. In general, shot length is a weak indicator of the content of a shot. In addition, the shot grouping mechanism is too reliant on the shot length threshold, which decides whether a shot is long enough to form its own group or should be grouped with other shots. In the latter case, the cumulative length of a short-shot group is not taken into account, which further compromises the quality of the groups for navigation purposes. Furthermore, the linking of segments based on whether they contain one long shot or multiple short shots is not of great use and it does not follow that segments linked in this fashion will be substantially related, either structurally, e.g. visually, or semantically. Thus, when users use the skip functionality, they may be transported to an unrelated part of the video, because it belongs in the same shot-length category as the currently viewed segment. In addition, the method does not allow users to view a summary for the segment they are about to skip to, or for any other relevant segments, or assess the relation of different segments to the current segment, which would allow them to skip to a more relevant segment.

US 2004/0234238 A1 relates to a video reproducing method. The next shot to be reproduced during video playback is automatically selected based on the current location information and a shot index information, then a section of that selected next shot is further selected, and then that section is reproduced. During the reproduction of that selected section, the next shot is selected and so on. Thus, during playback, the user may view only a start segment of each of the forward sequence of certain shots, i.e. shots whose length exceeds a threshold, after the current position, or an end segment of each of the reverse sequence of certain shots preceding the current position.

One drawback of the method is that, similarly to the method of WO 2004/059972 A1, the linking of shots based on their duration is not only too reliant on the shot length threshold for the linking, but also not of great use. Thus, it does not follow that video segments linked in this fashion will be substantially related, either structurally, e.g. visually, or semantically. Thus, when users use the playback functionality, they may view a series of loosely related segments whose underlying common characteristic is their length. In addition, the method does not allow users to view a summary for the segment they are about to skip to, or for any other relevant segments, or assess the relation of different segments to the current segment, which would allow them to skip to a more relevant segment.

U.S. Pat. No. 6,219,837 B1 relates to a video reproduction method. Summary frames are displayed on the screen during video playback. These summary frames are scaled down versions of past or future frames, relative to the current location in the video, and aim to allow users to better understand the video or serve as markers in past or future locations. Summary frames may be associated with short video segments, which can be reproduced by selecting the corresponding summary frame.

One drawback of the method is that the past and/or future frames displayed on the screen during playback are neither chosen because they are substantially related to the current playback position, e.g. visually or semantically, nor do they carry any information to allow users to assess their relation to the current playback position. Thus, the method does not allow for the kind of intelligent navigation where users may visualise only relevant segments and/or assess the similarity of different segments to the current playback position.

U.S. Pat. No. 5,521,841 relates to a video browsing method. Users are presented with a summary of a video in the form of a series or representative frames, one for each shot of the video. Users may then browse this series of frames and select a frame, which will result in the playback of the corresponding video segment. Then, representative frames which are similar to the selected frame will be searched for in the series of frames. More specifically, this similarity is assessed based on the low order moment invariants and the colour histograms of the frames. As a result of this search, a second series of frames will be displayed to the user, containing the same representative frames as the first series, but with their size adjusted according to their similarity to the selected frame, e.g. original size for the most similar and 5% of original size for the most dissimilar frames.

One drawback of the method is that the similarity assessment between video segments is based on the same data which is used for visualisation purposes, which are single frames of shots and, therefore, extremely limited. Thus, the method does not allow for the kind of intelligent navigation where users may jump between segments based on overall video segment content, such as a simple shot histogram or motion activity, or audio content, or other content, such as the people that appear in the particular segment, and so on. Furthermore, the display of the original representative frame series, where a user must select a frame to initiate the playback of the corresponding video segment and/or the retrieval of similar frames, may be acceptable for a video browsing scenario, but is cumbersome and will not serve users of a home cinema or other similar consumer application in a video navigation scenario, where the desire is for the system to continuously playback and identify video segments which are related to the current segment. In addition, the display of separate representative frame series alongside the original, following the similarity assessment between the selected frame and the other representative frames, is not convenient for users. This is, firstly, because the users are again presented with the same frames as in the original series, albeit scaled according to their similarity to the selected frame. If the number of frames is large, the users will again have to spend time browsing this frame series to find the relevant frames. In addition, the scaling of frames according to their similarity may defeat the purpose of showing multiple frames to the user, since the user will not be able to assess the content of a lot of them due to their reduced size.

WO 2004/061711 A1 relates to a video reproduction apparatus and method. A video is divided into segments, i.e. partially overlapping contiguous segments, and a signature is calculated for each segment. The hopping mechanism identifies the segment which is most similar to the current segment, i.e. the one the user is currently watching, and playback continues from that most similar segment, unless the similarity is below a threshold, in which case no hop takes place. Alternatively, the hopping mechanism may hop not to the most similar segment, but to the first segment it finds which is “similar enough” to the current segment, i.e. the similarity value is within a threshold. Hopping may also be performed by finding the segment which is most similar not to the current segment, but to a type of segment or segment template, i.e. action, romantic, etc.

One drawback of the method is that it does not allow users to view a summary for the segment they are about to skip to, or for any other relevant segments, or assess the relation of different segments to the current segment, which would allow them to skip to a more relevant segment.

Aspects of the invention are set out in the accompanying claims.

In broad terms, the invention relates to a method of representing a video sequence based on a time feature, such as time or temporal segmentation, and content-based metadata or relational metadata. Similarly, the invention relates to a method of displaying a video sequence for navigation, and a method of navigating a video sequence. The invention also provides an apparatus for carrying out each of the above methods.

A method of an embodiment of the invention comprises the steps of deriving one or more segmentations for a video, deriving metadata for a current segment, the current segment being related to the current playback position, e.g. being the segment that contains the current playback position or being the previous segment of the segment that contains the current playback position, assessing a relation between the current and other segments based on the aforementioned metadata, displaying a summary or representation of some or all of said other segments along with at least one additional piece of information about each segment's relation to the current segment, and/or displaying a summary or representation of some or all of said other segments, whereby each and every of the displayed segments fulfils some relevance criteria with regards to the current segment, and allowing users to select one of the said displayed segments to link to that segment and make it the current segment and move the playback position there.

Embodiments of the invention provide a method and apparatus for navigating and accessing video content in a fashion which allows users to view a video and, at the same time, view summaries of video segments which are related to the video segment currently being viewed, assess relations between the currently viewed and the related video segments, such as their temporal relation, similarity, etc., and select a new segment to view.

Advantages of the invention include the linking of video segments based on a variety of structural and semantic metadata of the video segments, that users can view summaries or other representations of video segments which are relevant to a given segment and/or summaries or other representations of video segments combined with other information which indicates their relation to a given segment, that users can refine the choice of the video segment to navigate to, and that users can navigate to a segment without browsing the entire list of segments the video comprises.

Embodiments of the invention will be described with reference to the accompanying drawings, of which:

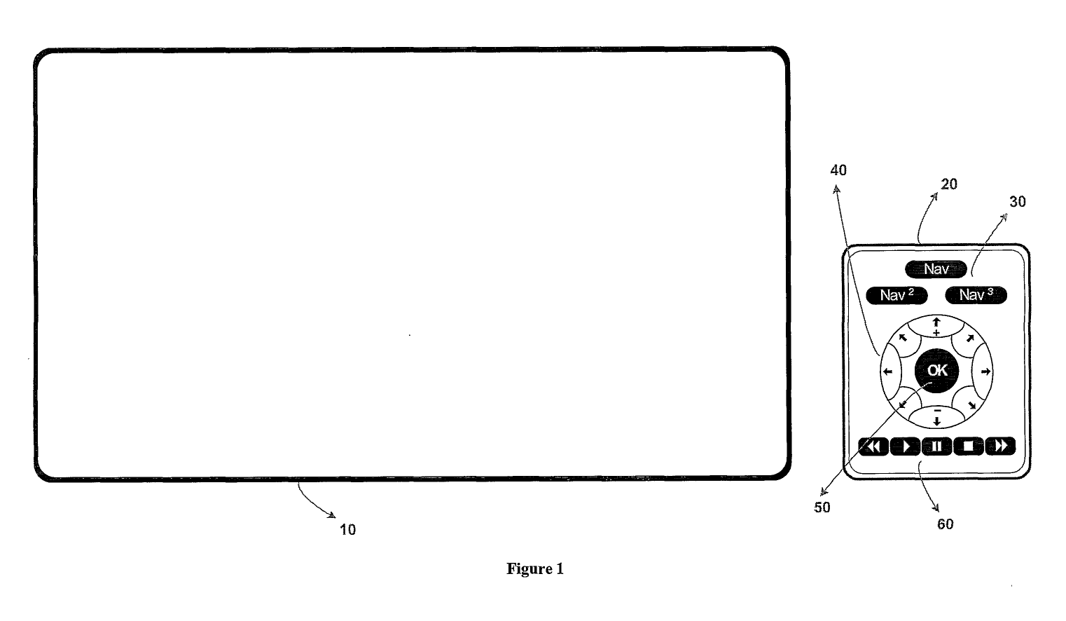

FIG. 1 shows a video navigation apparatus of an embodiment of the invention;

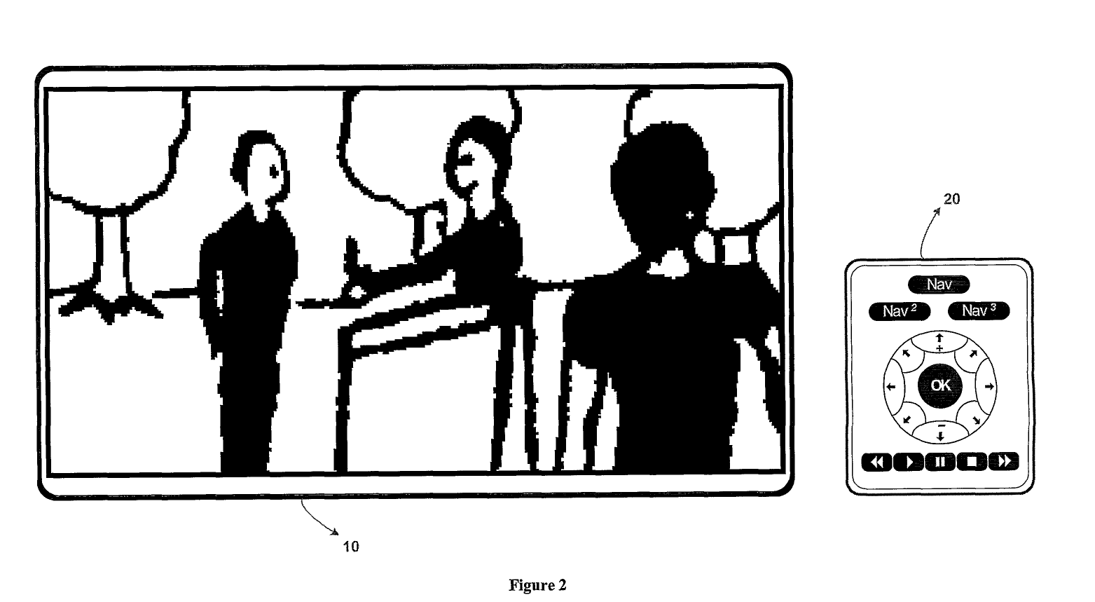

FIGS. 2 to 16 show the video navigation apparatus of FIG. 1 with image displays illustrating different steps of a method of an embodiment of the invention.

In the method of an embodiment of the invention, a video has associated with it temporal segmentation metadata. This information indicates the separation of the video into temporal segments. There are many ways in which a video may be divided into temporal segments. For example, a video may be segmented based on time information, whereby each segment lasts a certain amount of time, e.g. the first 10 minutes is the first video segment, the next 10 minutes is the second segment and so on, and segments may even overlap, e.g. minutes 1-10 form the first segment, minutes 5 to 14 form the second segment and so on. A video may also be divided into temporal segments by detecting its constituent shots. Methods of automatically detecting shot transitions in video are described in our co-pending patent applications EP 05254923.5, entitled “Methods of Representing and Analysing Images, and EP 05254924.3, also entitled “Methods of Representing and Analysing Images”, incorporated herein by reference. Then, each shot may be used as a segment, or several shots may be grouped into a single segment. In the latter case, the grouping may be based on number of shots, e.g. 10 shots to one segment, or total duration, e.g. shots with a total duration of five minutes to one segment, or the shots' characteristics, such as visual and/or audio and/or other characteristics, e.g. shots with the same visual and/or audio characteristics being grouped into a single segment. Shot grouping based on such characteristics may be achieved using the methods and descriptors of the MPEG-7 standard, a description of which may be found in the book “Introduction to MPEG-7: Multimedia Content Description Interface” by Manjunath, Salembier and Sikora (2002). Obviously, the above are only examples of how a video may be segmented into temporal segments and do not constitute an exhaustive list. According to the invention, a video may have more than one type of temporal segmentation metadata associated with it. For example, a video may be associated with a first segmentation into time-based segments, a second segmentation into shot-based segments, a third segmentation into shot-group-based segments, and a fourth segmentation based on some other method or type of information.

The temporal segments of the one or more different temporal segmentations may have segment description metadata associated with them. This metadata may include, but is not limited to, visual-oriented metadata, such as colour content and temporal activity of the segment, audio-oriented metadata, such as a classification of the segment as music or dialogue and so on, text-oriented metadata, such as the keywords which appear in the subtitles for the segment, and other metadata, such as the names of the people which are visible and/or audible within the segment. Segment description metadata may be derived from the descriptors of the MPEG-7 standard, a description of which may be found in the book “Introduction to MPEG-7: Multimedia Content Description Interface” by Manjunath, Salembier and Sikora (2002). Such segment description metadata is used to establish relationships between video segments, which are then used for the selection and/or display of video segments during the process of navigation according to the invention.

In addition to, or instead of, the segment description metadata, the temporal segments of the one or more different temporal segmentations may have segment relational metadata associated with them. Such segment relational metadata is calculated from segment description metadata and then used for the selection and/or display of video segments during the process of navigation. Segment relational metadata may be derived according to the methods recommended by the MPEG-7 standard, a description of which may be found in the book “Introduction to MPEG-7: Multimedia Content Description Interface” by Manjunath, Salembier and Sikora (2002). This metadata will indicate the relationship, such as similarity, between a segment and one or more other segments, belonging to the same segmentation or a different segmentation of the video, according to segment description metadata. For example, the shots of a video may have relational metadata indicating their similarity to every other shot in the video according to the aforementioned visual-oriented segment description metadata. In another example, the shots of a video may have relational metadata indicating their similarity to larger shot groups in the video according to the aforementioned visual-oriented segment description metadata or other metadata. In an embodiment of the invention, relational metadata may be organised in the form of a relational matrix for the video. In different embodiments of the invention, a video may be associated with segment description metadata or segment relational metadata or both.

Such temporal segmentation metadata, segment description metadata and segment relational metadata may be provided along with the video, e.g. on the same DVD or other media on which the video is stored, placed there by the content author, or in the same broadcast, placed there by the broadcaster, and so on. Such metadata may also be created by and stored within a larger video apparatus or system, provided that said apparatus or system has the capabilities of analysing the video and creating and storing such metadata. In the event that such metadata is created by the video apparatus or system, it is preferable that the video analysis and metadata creation and storage takes place offline rather than online, i.e. when the user is not attempting to use the navigation feature which relies on this metadata rather than when the user is actually using said feature.

FIG. 1 shows navigation apparatus according to an embodiment of the invention. The video is displayed on a 2-dimensional display 10. In a preferred embodiment of the invention, the user controls video playback and navigation via a controller 20. Controller 20 comprises navigation functionality buttons 30, directional control buttons 40, selection button 50, and playback buttons 60. In different embodiments of the invention, the controller 20 may comprise a different number of navigation, directional, selection and playback buttons. In other embodiments of the invention, the controller 20 may be replaced by other means of controlling the video playback and navigation, e.g. a keyboard.

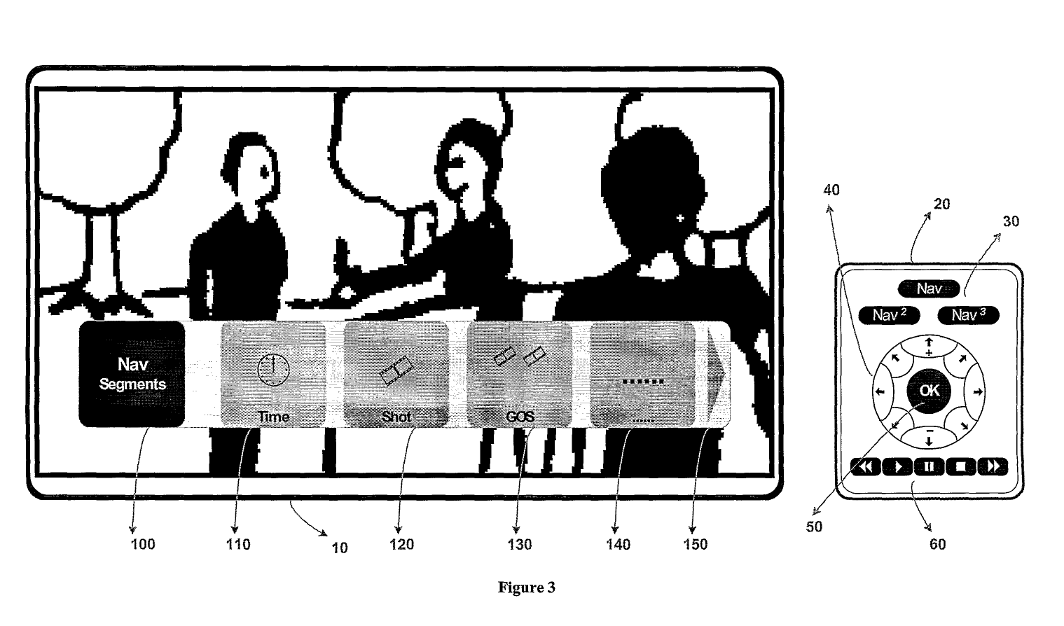

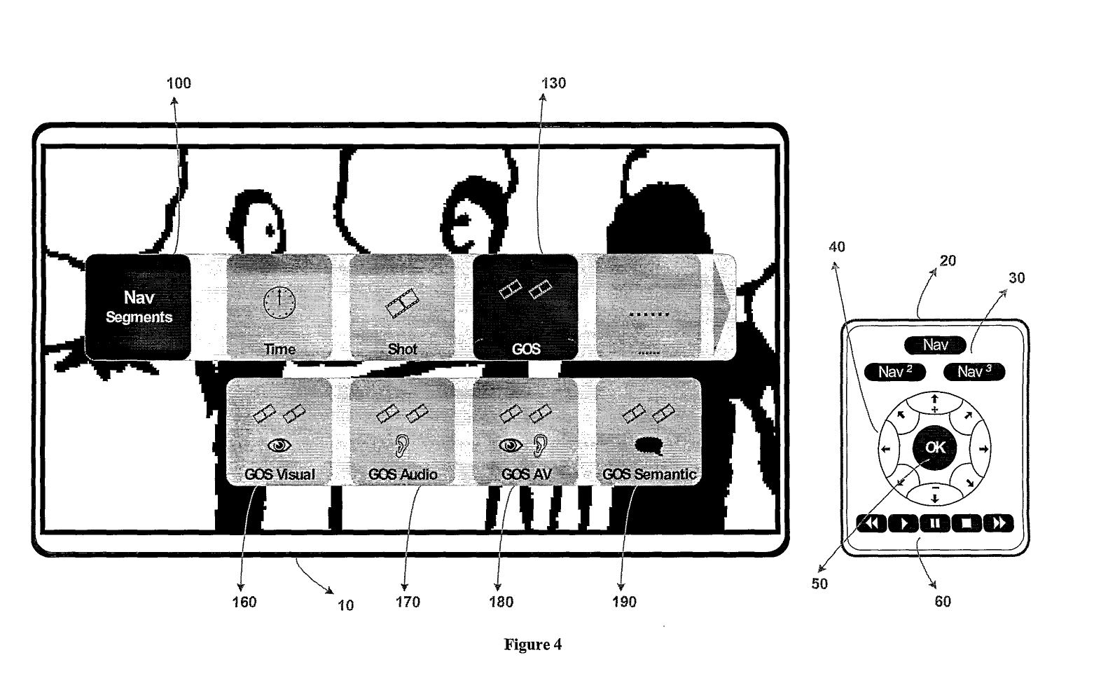

FIGS. 2-16 illustrate the operation of an embodiment of the invention. FIG. 2 shows an example of a video being played back on the display 10. As shown in FIG. 3, the user may activate the navigation functionality by pressing one the intelligent navigation buttons 30, for example the top button ‘Nav’. The navigation functionality may be activated while playback continues, or the user may pause the playback using the playback controls 60 before activating the navigation feature. As shown in FIG. 3, activating the navigation feature results in menu 100, comprising menu items 100 to 140, being displayed to the user on top of the video being played back. In this menu, the user may select the particular video temporal segmentation metadata to use for the navigation. For example, the user may be interested in navigating between coarse segments, in which case the Group-Of-Shots ‘GOS’ option 130 is more appropriate, or may be interested in fine segment navigation, in which case the ‘Shot’ option 120 may be more appropriate, and so on. The user may go to the desired option using the directional control buttons 40 and make a selection using the selection button 50. If more menu items are available than can be fitted on the screen, the user may view those items by selecting the menu arrow 150 (this may apply for any menus of embodiments even if not explicitly mentioned or apparent on all illustrations). As shown in FIG. 4, selecting a menu item may result in a submenu being displayed. In FIG. 4, for example, the menu item Group-Of-Shots ‘GOS’ 130 contains the items ‘GOS Visual’ 160, ‘GOS Audio’ 170, ‘GOS AV’ 180 (Audio-Visual) and ‘GOS Semantic’ 190 (whereby, for example, shots are grouped based on the subplot to which they belong). Then, selecting a submenu option may result in a further menu, and so on (this simple functionality may apply for any menus of embodiments even if not explicitly mentioned or apparent on all illustrations).

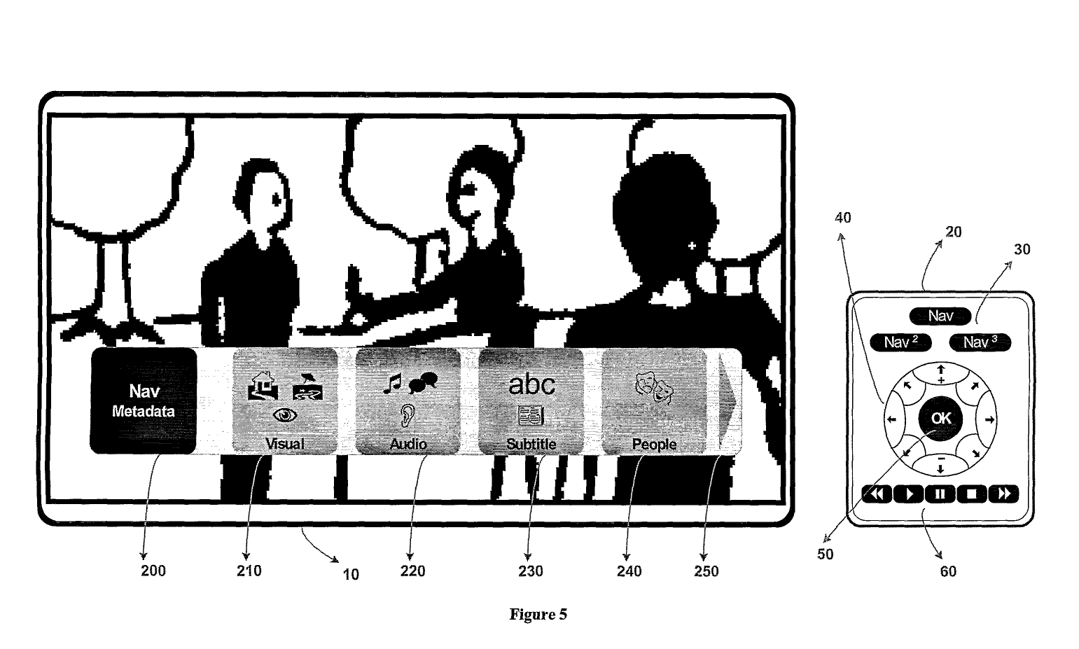

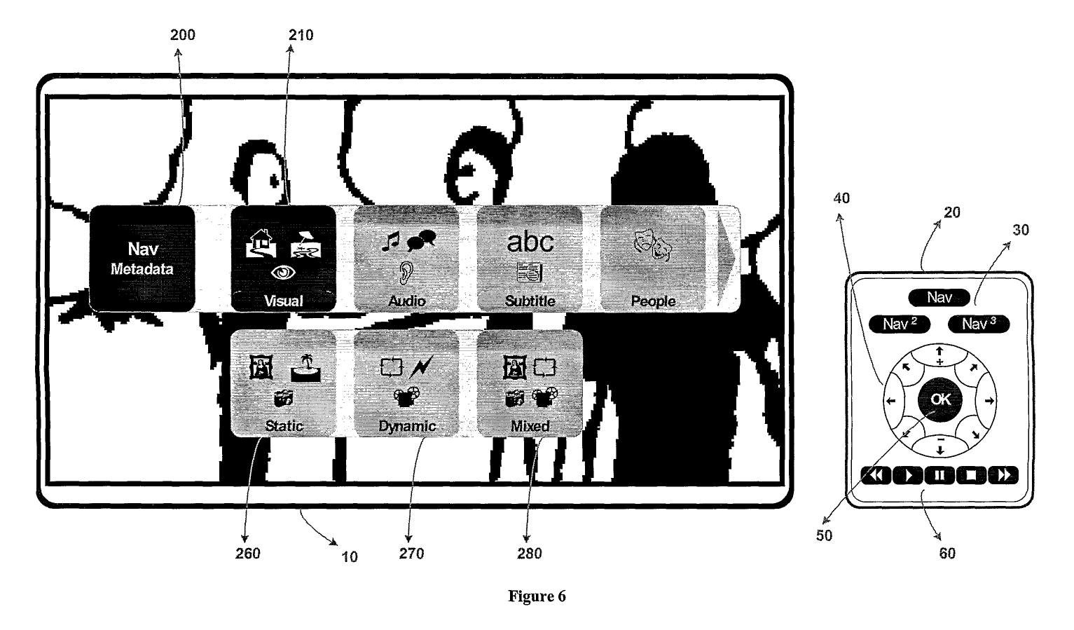

FIG. 5 illustrates that, after the final selection on the video segmentation has been made, a new menu 200, comprising menu items 210 to 240, is displayed, where the user may select the segment description metadata and/or segment relational metadata to be used for the navigation. For example, the user may be interested in navigating based on the visual relation between video segments, in which case the ‘Visual’ option 210 is appropriate, or may be interested in navigating based on audio relation, in which case the ‘Audio’ option 220 is appropriate, and so on. The user may select the appropriate choice as for the previous menu. As shown in FIG. 6, selecting a menu item may result in a submenu being displayed. In FIG. 6, for example, the menu item ‘Visual’ 210 contains the items ‘Static’ 260 (for static visual features, such as colour), ‘Dynamic’ 270 (for dynamic visual features, such as motion) and ‘Mixed’ 280 (for combined static and dynamic visual features). Then, selecting a submenu option may result in a further menu, and so on.

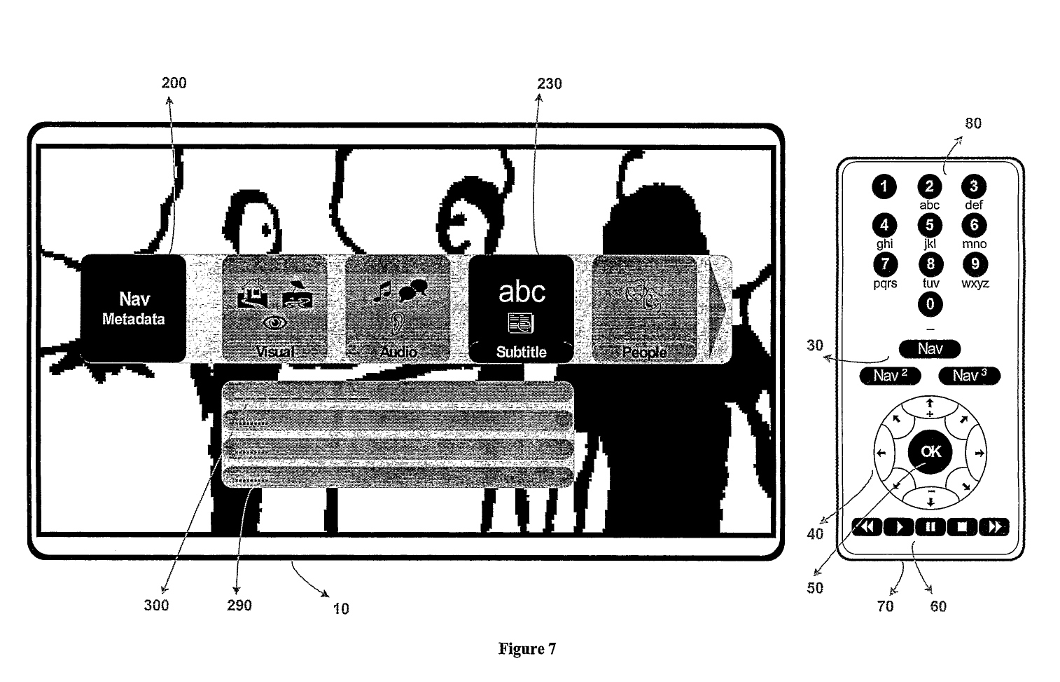

FIG. 7 shows another example of segment metadata selection. There, the ‘Subtitle’ option 230 has been selected from the metadata menu 200, resulting in the display of submenu 290. This submenu contains keywords of the video that are found in the current segment, the selection of one or more of which will link the segment to other segments for the navigation. As shown in FIG. 7, the menu 290 may also contain a “text input” field 300, where the user may enter any word to find other segments which contain that word. This text input could easily, but not uniquely, be achieved using the controller 70, which comprises all the controls of controller 20 as well as a numerical keypad 80.

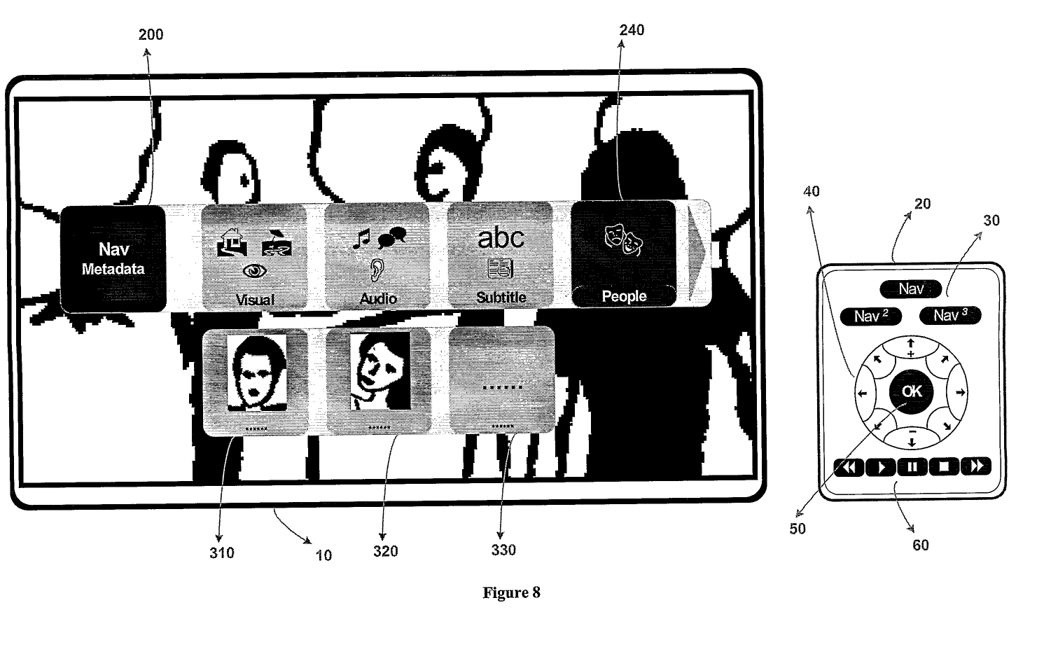

FIG. 8 shows another example of segment metadata selection. There, the ‘People’ option 240 has been selected from the metadata menu 200, resulting in the display of submenu options 310 to 330, each corresponding to a distinct face found in the current segment. Selecting one or more of the faces will then link the segment to the other segments which contain the same people for the navigation. As shown in FIG. 8, each of the items 310 to 330 also contains an optional description field at the bottom. This could contain information such as the name of an actor, and may be entered manually, for example by the content author, or automatically, for example using a face recognition algorithm on a database of known faces.

It is possible for a user to select multiple segment metadata for a single navigation, e.g. both ‘Audio’ and ‘Visual’, or ‘People’ and ‘Subtitle’, etc. This will allow the user to navigate based on multiple relations between segments, e.g. navigate between segments which are similar in terms of both the ‘Audio’ and ‘Visual’ metadata, or in terms of either one or both of the two types of metadata, or in terms of either one but not the other, etc.

FIGS. 3-8 demonstrate how a user may first select the desired video segmentation and then the desired segment description and/or relational metadata for the navigation. In different embodiments of the invention, this order may be reversed, with users first selecting the desired description and/or relational metadata and then the video segmentation. In either case, embodiments of the invention may “hide” from the user those metadata/segmentation options which are not valid for the already selected segmentation/metadata. In a preferred embodiment of the invention, the most suitable metadata/segmentation will be suggested to the user based on the already selected segmentation/metadata.

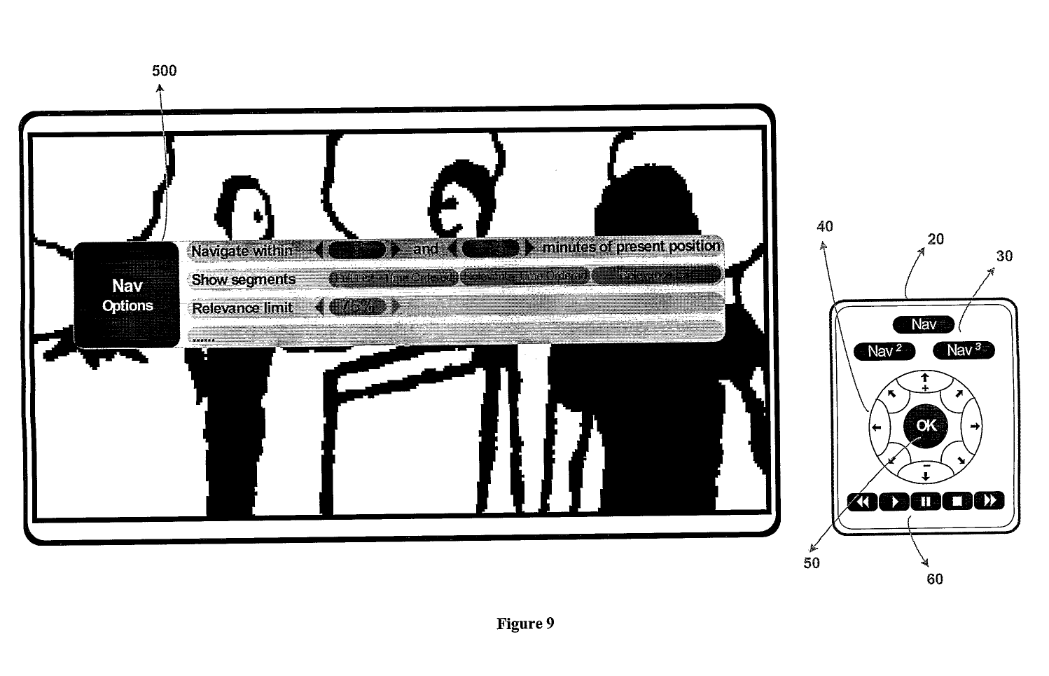

FIG. 9 illustrates that, after the final selection on the video segment description and/or relational metadata has been made, a new menu 500 is displayed, where the user may set options pertaining to the selection of segments during the navigation process, or the method of display of these segments, etc. For example, the top option in FIG. 9 is used to specify how “far” in time from the current segment the navigation mechanism will venture to find related segments. Alternatively, the scope of the navigation may be chosen in terms of segments or chapters instead of time. The second and third options in FIG. 9 pertain to which segments will be presented to the user and how, as is discussed below.

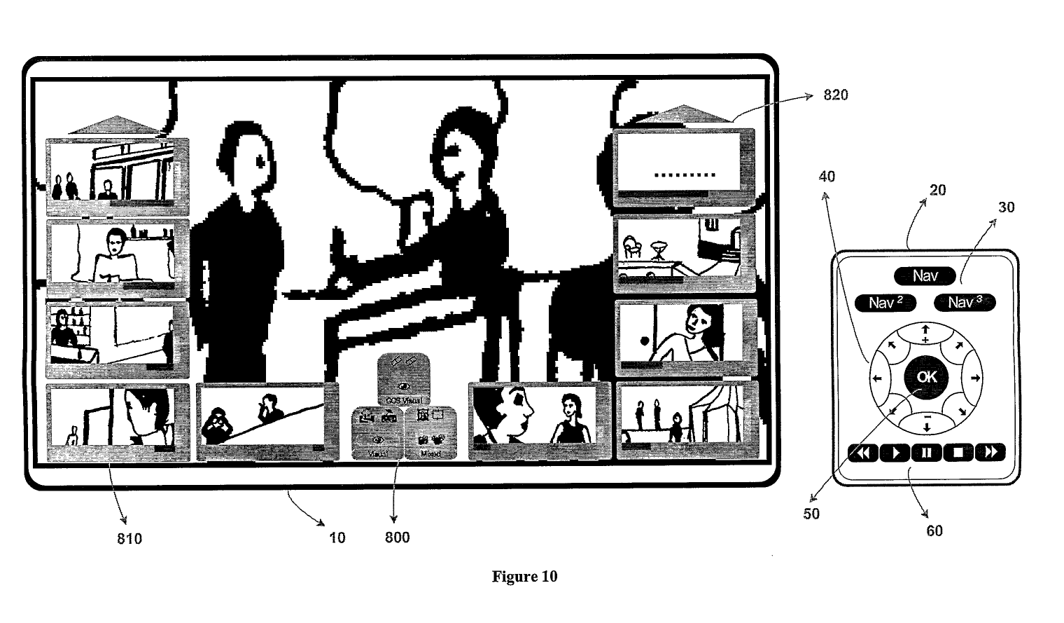

After the finalisation of options as illustrated in FIG. 9, the intelligent navigation mechanism identifies those video segments which are relevant to the current segment and presents them to the user, as illustrated in FIGS. 10-14. It should be noted that it is not necessary for a user to go through the process illustrated in FIGS. 2-9 every time the navigation feature is used. An additional navigation button, such as ‘Nav²’ of the button group 30, may be used to activate the navigation functionality with the same segmentation, metadata and other options as the last time it was used. Also, all the aforementioned preferences and options may be set, in one or more different configurations, offline rather than online i.e. when the user is not attempting to use the navigation feature or watch a video, and mapped to separate buttons, such as ‘Nav³’ of the button group 30, which then become “macros” for a user's most commonly used navigation preferences and options. Thus, a user may press a single button and immediately view the video navigation screen with the relevant video segments, as illustrated in FIGS. 10-14.

As previously discussed, in a preferred embodiment of the invention the segments which are relevant to the currently displayed video segment may be most easily identified from the segment relational metadata or relational matrix, if available. If such metadata is not available, then the system can ascertain the relationship between the current segment and other segments from the segment description metadata, i.e. create the segment relational metadata online. This, however, will make the navigation functionality slower. If the segment description metadata is not available, then the system may calculate it from the video segments, i.e. create the segment description metadata online. This, however, will make the navigation functionality even slower.

FIG. 10 illustrates how the video navigation screen might appear in an embodiment of the invention, with both the current video segment being played back and the relevant segments being shown on the same display. As can be seen, the current video segment is still displayed on the display 10 as during normal playback. Optionally, icons 800 at the bottom of the display indicate the settings which gave rise to the navigation screen and results. In this example, the icons indicate that the user is navigating between groups of shots and using both static and dynamic visual metadata Overlaid on the current video segment, and along the periphery of the display, are representations or summaries of other video segments 810 that the user may navigate to.

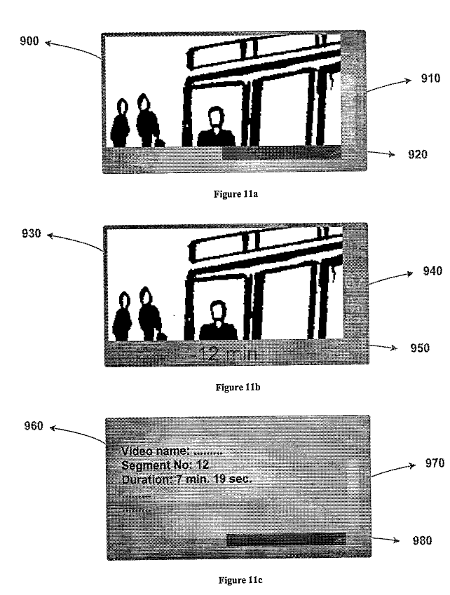

This type of video segment representation is shown in greater detail in FIG. 11a and comprises video data 900, a horizontal time bar 920, and a vertical relevance bar 910. In FIG. 11a, the video data is a representative frame of the segment. In a preferred embodiment of the invention, the video data will be a short video clip. In another embodiment of the invention, the video data will be a more indirect representation of the segment, such as a mosaic or montage of representative frames of the video segment. The horizontal time bar 920 extends from left to right if the segment in question follows the current segment and from right to left if the segment in question precedes the current segment. The length of the bar shows how distant the segment in question is from the current segment. The vertical bar 910 extends from bottom to top and its length indicates the relevance or similarity of the segment in question to the current segment. Alternative video segment representations may be seen in FIGS. 11b and 11c. In the former, there is still video data 930, but the horizontal and vertical bars have been replaced by numerical fields 950 and 940 respectively. In the latter, the segment representation comprises a horizontal time bar 980, and a vertical relevance bar 970 as in FIG. 11a, but the video data has been replaced by video metadata 960. In the example of FIG. 11c, the metadata comprises information about the video segment including the name of the video that it belongs to, a number identifying its position in the timeline of the video, its duration, etc. Other metadata may also be used in addition to or instead of this metadata, such as an indication of whether the segment contains music, a panoramic view of one of the scenes of the segment, e.g. created by performing image registration and “stitching” on the video frames, etc.

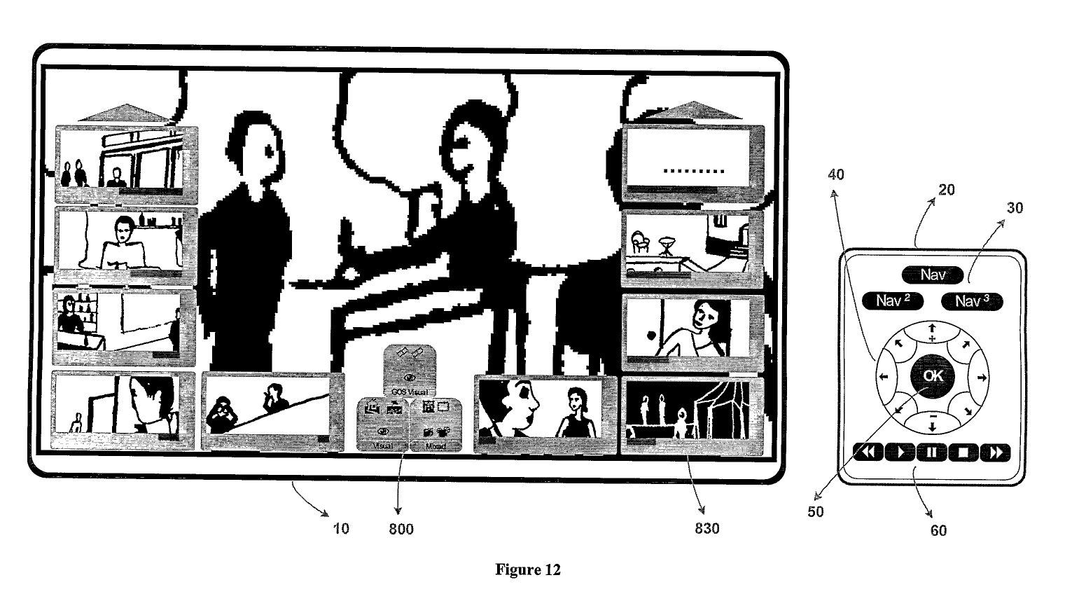

FIG. 10 illustrates one example of the navigation functionality, whereby all the segments within a specified window, such as a time-based or shot-number-based window, around the current segment are shown to the user, regardless of their similarity or other relation to the current segment. In such a scenario, the user selects the video segment to navigate to based on the time and relevance bars of the displayed video segments. The video segments are arranged time-wise, with older segments appearing at the left of the display and newer segments at the right. If more video segments are available than can be fitted on the screen, the user may view those items by selecting the menu arrows 820. As can be seen in FIG. 12, the user may select one of the displayed segments, e.g. 830, using the directional controls 40 and selection button 50, and playback will resume from that video segment.

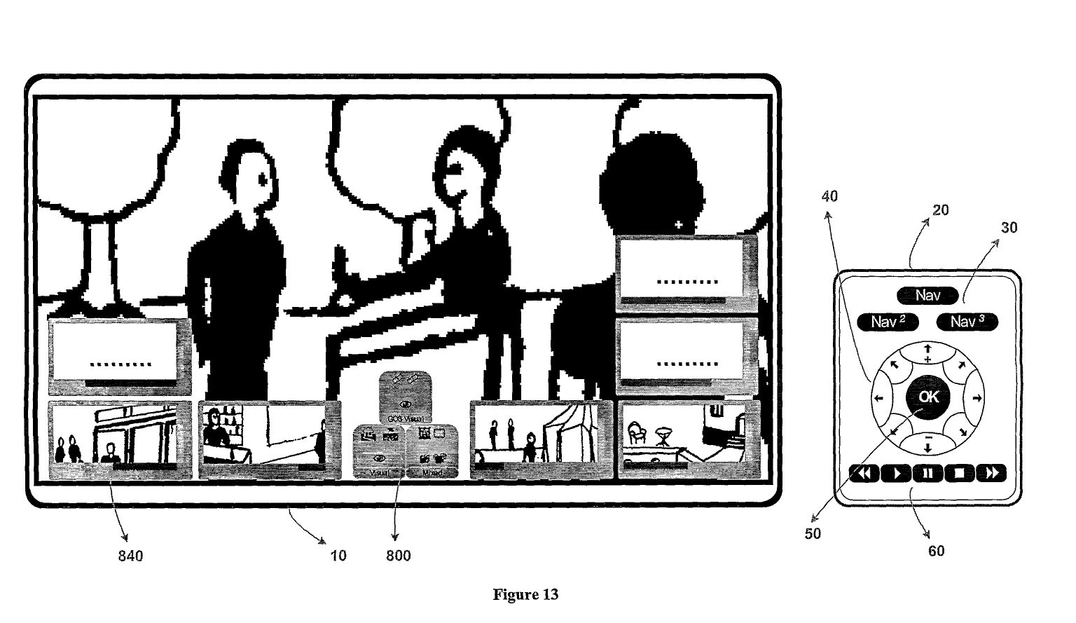

FIG. 13 illustrates another example of the navigation functionality. That navigation screen is very similar to the one of FIG. 10; the difference lies in the fact that only the most relevant or similar segments 840, according to some specified threshold or criterion, are shown to the user for navigation purposes. As before, the user may select one of the displayed segments, using the directional controls 40 and selection button 50, and playback will resume from that video segment.

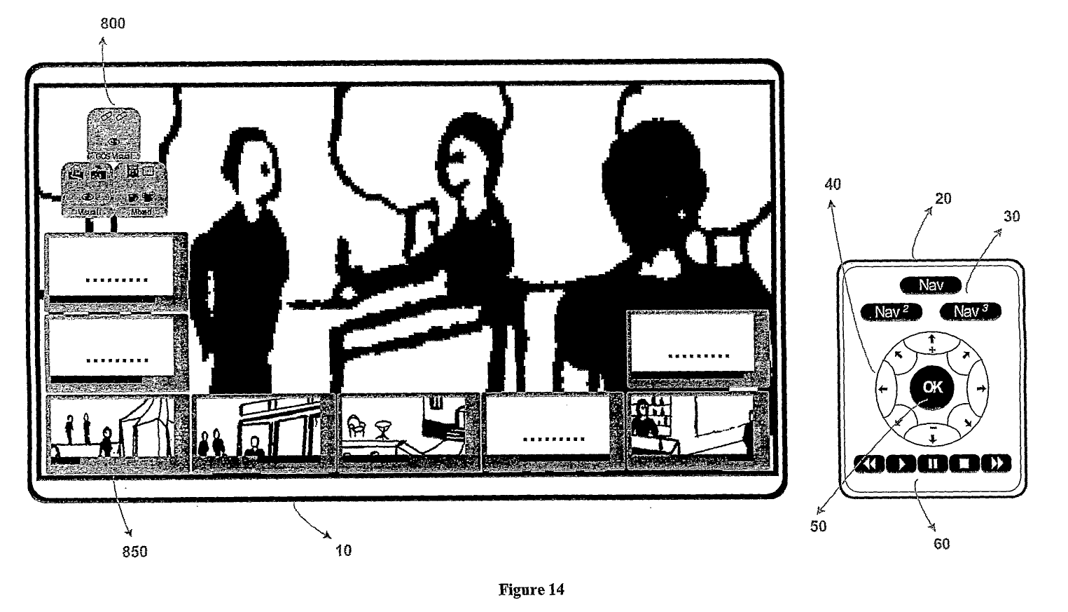

FIG. 14 illustrates yet another example of the navigation functionality. As for the example of FIG. 13, only the most relevant or similar segments 850, according to some specified threshold or criterion, are shown to the user for navigation purposes. This time, however, the video segments are sorted by relevance rather than time, with the most relevant segments appearing at the left of the display and the least similar at the right. The time relation of the video segments to the current video segment may still be ascertained by their time bars.

As previously discussed, the navigation feature may be used either during normal playback of a video or while the video is paused. In the former case, it possible that the playback will advance to the next segment before the user has decided which segment to navigate to. In that case, a number of actions are possible. For example, the system might deactivate the navigation feature and continue with normal playback, or it might keep the navigation screen active and unchanged and display an icon indicating that the displayed video segments do not correspond to the current segment but a previous segment, or it may automatically update the navigation screen with the video segments that are relevant to the new current segment, etc.

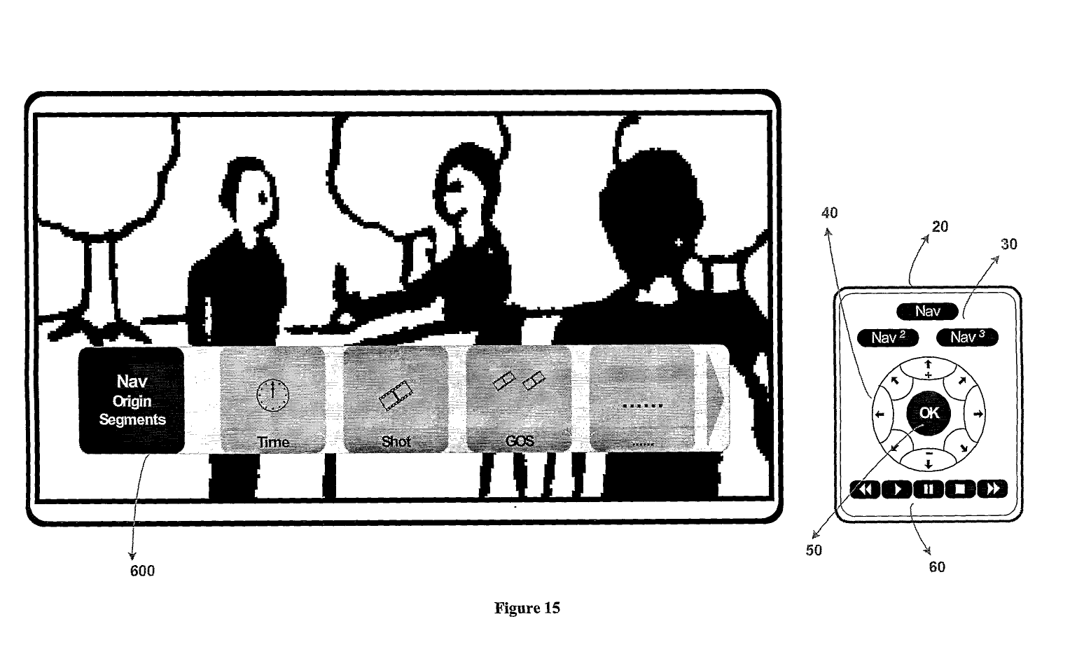

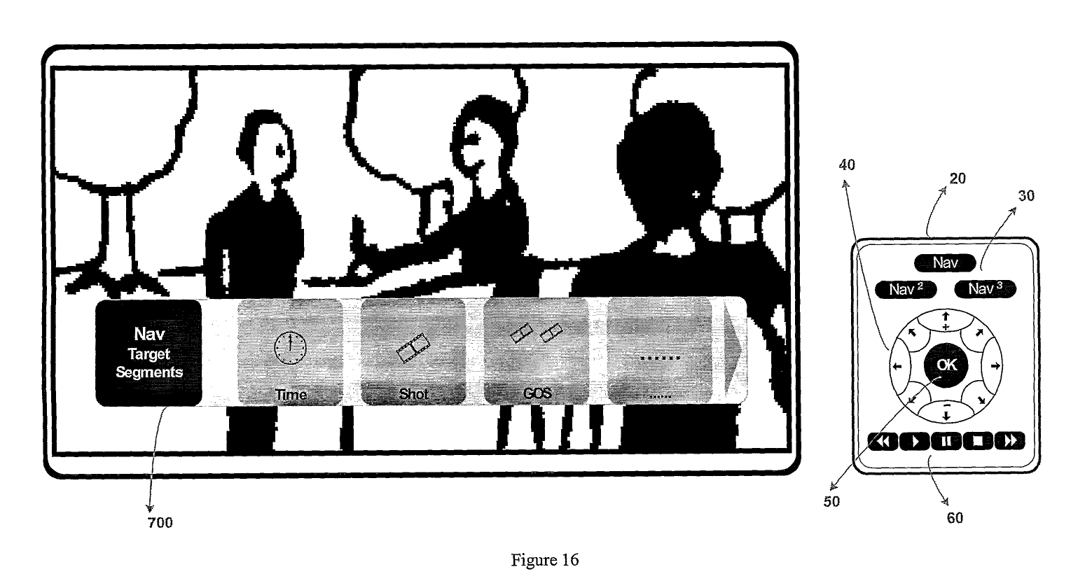

It is also possible to establish relationships between segments of different segmentations. This, for example, allows a user to link a short segment, such as a shot or even a frame, to longer segments, such as shot groups or chapters. Depending on the video segments and metadata, this may be achieved by directly establishing the relationship between the segments of the different segmentations or by establishing the relationships between segments of the same segmentation and then placing the relevant segments in the context of a different segmentation. In either case, such a functionality will require the user to specify the navigation ‘Origin’ 600 and ‘Target’ 700 segmentations, as illustrated in FIGS. 15 and 16 respectively.

Other modes of operation for the navigation functionality are also possible. In one such example, the “current” segment for navigation purposes is not the segment currently being reproduced, but the immediately preceding segment. This is because, very often, users will watch a segment in its entirety and then wish to navigate to other relevant segments, by which time the playback will have moved on. Another such example is the video apparatus not displaying any segments at all, but automatically skipping to the next or previous, according to the user's input, most relevant segment according to some specified threshold. The video apparatus or system may also allow users to undo their last navigation step, and go back to the previous video segment.

Although the previous examples consider navigation within a video, the invention is also directly applicable to navigation between segments of different videos. In such a scenario, where relevant segments are sought for in the current and/or different videos, the operation may be essentially as described above. One difference is that the horizontal time bar of the video segment representations on the navigation screen could be removed for the video segments corresponding to the different videos, since a segment from a video neither precedes nor follows a segment from another video, or could carry some other useful information, such as the name of the other video and/or time information indicating whether the video is a recording that is older or newer than the current video, if applicable, etc.

Similarly, the invention is also applicable to navigation between entire videos, using video-level description and/or relational metadata, and without the need for temporal segmentation metadata. In such a scenario the operation may be essentially as described above.

Although the illustrations herein show the different visual elements of the video navigation functionality, such as menus and segment representations, displayed on the same screen on which the video is reproduced, by overlaying them on top of the video, this need not be so. Such visual elements may be displayed concurrently with the video but on a separate display, for example a smaller display on the remote control of the larger video apparatus or system.

The invention can be implemented for example in a video reproduction apparatus or system, including a computer system, with suitable software and/or hardware modifications. For example, the invention can be implemented using a video reproduction apparatus having control or processing means such as a processor or control device, data storage means, including image storage means, such as memory, magnetic storage, CD, DVD etc, data output means such as a display, input means such as a controller or keyboard, or any combination of such components together with additional components. Aspects of the invention can be provided in software and/or hardware form, or in an application-specific apparatus or application-specific modules can be provided, such as chips. Components of a system in an apparatus according to an embodiment of the invention may be provided remotely from other components, for example, over the internet.

1. A method of deriving a representation of a video sequence comprising a plurality of frames, the method comprising deriving metadata expressing at least one temporal characteristic of a frame or group of frames, and one or both of metadata expressing at least one content-based characteristic of a frame or group of frames and relational metadata expressing relationships between at least one content-based characteristic of a frame or group of frames and at least one other frame or group of frames, and associating said metadata and/or relational metadata with the respective frame or group of frames.

2. The method of claim 1 comprising segmenting the video sequence into groups of frames according to at least one type of temporal segmentation, wherein the temporal metadata is related to the temporal segmentation, and the content-based metadata or relational metadata is derived from respective groups of frames.

3. The method of claim 2 comprising segmenting the video sequence into groups of frames according to two or more different types of temporal segmentations, and deriving metadata and/or relational metadata for each of the different types of segmentations.

4. The method of any claim 2 or claim 3 wherein the temporal characteristic represents the temporal segmentation.

5. The method of any preceding claim wherein the temporal characteristic represents the location of the frame or group of frames in the video sequence.

6. The method of any preceding claim wherein the content-based characteristics comprise one or more of visual characteristics, audio characteristics, text, keywords, people, and author.

7. The method of any preceding claim wherein relational metadata uses similarity measures between metadata.

8. A method of displaying a video sequence for navigation, using a representation derived using the method of any preceding claim.

9. The method of claim 8 further comprising, for a first frame or group of frames, selecting at least one other frame or group of frames based on said relational metadata, or based on a relationship between respective metadata.

10. The method of claim 9 wherein the first frame or group of frames is the current frame or group of frames being displayed, or the previous or successive frame or group of frames.

11. The method of claim 9 or claim 10 comprising selecting at least one other frame or group of frames based on a time window.

12. The method of any of claims 9 to 11 further comprising displaying a representation of said selected frame or group of frames.

13. The method of claim 12 comprising ordering the displayed representations according to one or more of time, relevance or similarity based on time, relevance or similarity based on content.

14. The method of claim 12 or claim 13 wherein the displayed representation comprises one or more of information regarding content, or relevance or similarity based on content, information regarding time, or relevance or similarity based on time, and information regarding metadata.

15. The method of any of claims 8 to 14 further comprising displaying options for navigation including one or more of: at least one type of temporal segmentation, at least one type of content-based characteristic, time or location in the video sequence.

16. The method of any of claims 9 to 15 further comprising displaying the selected group of frames or a group of frames including the selected frame.

17. A method of navigating a video sequence, using a representation derived using the method of any of claims 1 to 7.

18. The method of claim 17, wherein a video sequence is displayed using the method of any of claims 8 to 16.

19. The method of claim 17 or claim 18, comprising selecting options, including, for example, at least one type of temporal segmentation, at least one type of content-based characteristic, time or location in the video sequence.

20. The method of any preceding claim for two or more different video sequences, optionally omitting temporal metadata.

21. A representation of a video sequence derived using the method of any of claims 1 to 7.

22. A storage medium or storage means storing a video sequence and a representation of the video sequence derived using the method of any of claims 1 to 7.

23. Apparatus for executing the method of any of claims 1 to 20

24. Apparatus of claim 20 comprising one or more of a control means or processor, a storage medium or storage means, and a display.

25. Apparatus of claim 23 or claim 24 comprising a storage medium or storage means storing at least one representation of a video sequence derived using the method of any of claims 1 to 7.

26. Computer program for executing the method of any of claims 1 to 20 or computer-readable storage medium storing such a computer program.
